(19) United States
(12) Patent Application Publication
(10) Pub. No.: US 2005/0072376 A1
(43) Pub. Date: Apr. 7, 2005

(54) Pet pack and cover

(76) Inventor: Nancy C. Kerrigan, Woburn, MA (US)

Correspondence Address: Todd S. Parkhurst;Holland & Knight LLC, 30th Floor, 131 South Dearborn St., Chicago, IL, 60603, US

(21) Appl. No.: 10/677,571

(22) Filed: Oct. 2, 2003

(51) Int. Cl. A01K 13/00

(52) U.S. Cl. 119/850

(57) ABSTRACT

The present invention discloses pet accessories such as pet packs and coats which attach easily and allow a pet to carry its belongings. In one embodiment of the invention, pet pack comprises a top side with a plurality of pockets, a hook and eyelet fastener which attaches to existing pet harnesses. In another embodiment, a pet coat which at least substantially covers a pet is comprised of a durable, water resistant material. The pet coat also comprises a pocket and a hook and eyelet fastener which attaches to exiting harnesses.

### BACKGROUND OF THE INVENTION

1. Field of the Invention

The present invention relates, in general, to the field of pet accessories and care. More specifically, the present invention is directed to a pet pack and coat that allow a pet to carry its items.

2. Description of the Related Art

The present invention overcomes the shortcomings and the deficiencies of the prior art and is directed to pet harness accessories which solve or at least substantially reduce the impact of these problems associated with existing pet packs and attire.

Pet accessories such as packs and attire have become popular in the marketplace. More and more people consider their pet as a part of the family. As a result, many pets travel with their families. Moreover, people have increased walking with their pets for their own exercise as well as to exercise, entertain, and play with the animal.

Currently, various pet accessories such as packs and attire are provided by various manufacturers and pet shops. Pet packs such as pouches attached to collars and attire such as short sweaters are presently available. The pouches allow pets to carry small items while the sweaters provide cover over the front quarters and part of the body. However, such conventional systems are deficient in several ways.

One significant deficiency of conventional pet accessories is that they do not allow the pets to carry their accessories. Pouches are limited because they must be attached to collars around the pets' necks. Therefore, pets are precluded from carrying heavy or large items lest they injure their necks. Additionally, people must carry the pet care equipment and their own items. This may be inconvenient during trips, walks or while running errands.

Another deficiency of existing accessories, specifically attire, is it does not provide adequate protection. Existing sweaters and attire only cover the front legs and potentially half the body. This is insufficient because half of the body is still exposed to weather conditions such as cold or rain. In addition, existing sweaters provide inadequate cover from water. This may cause the pets to be sick and result in potentially serious health conditions.

Finally, conventional pet accessories such as packs and attire are difficult to attach to the pet. This results in uncomfortable conditions for the pet and waste of time for the owners. In fact, often times owners will not walk or travel with their pets during conditions requiring attire.

The present invention overcomes the shortcomings and deficiencies of the prior art and is directed to systems and methods which solve or at least substantially reduce the impact of these problems associated with existing pet packs and attire.

One object and advantage of the present invention is to provide a pack and pet attire that is easy to attach to the pet.

It is yet another object and advantage of the present invention to provide pet accessories such as packs and pet attire that attach to existing pet body harnesses.

The above and other objects, advantages, and features of the present invention will become readily appreciated and understood from consideration of the following detailed description of the preferred embodiments of the present invention when taken together with the accompanying drawings of the present invention.

### SUMMARY OF THE INVENTION

In accordance with the foregoing objects, in one embodiment, the present invention comprises a pet pack comprising a plurality of pockets that is easily attached to existing harnesses and can be worn over a pet's back. In another embodiment, the present invention comprises a coat with a plurality of pockets, covers at least a substantial portion of the pet's body and easily attaches to existing harnesses.

### BRIEF DESCRIPTION OF THE DRAWINGS

FIG. 1. illustrates a pet pack attached to a pet;

FIG. 2. is an isometric view of the pet pack from the right side;

FIG. 3. is an isometric view of the pet pack from the left side;

FIG. 4. shows the top side of the pet pack;

FIG. 5. displays the underside of the pet pack;

FIG. 6. shows a pet coat attached to a pet;

FIG. 7. provides a top view of the unfolded pet coat;

FIG. 8. displays the underside of the pet coat with the harness attachment mechanism;

FIG. 9. presents the pet coat with an attached harness;

FIG. 10. suggests how the pet coat is wrapped around the harness and a pet;

### DETAILED DESCRIPTION OF THE INVENTION

While various embodiments of the present invention are discussed in detail below, it should be appreciated that the present invention provides inventive concepts that can be embodied in wide variety of specific contexts. The specific embodiments discussed are merely illustrative of specific ways to make and use the invention and do not limit the scope of the invention.

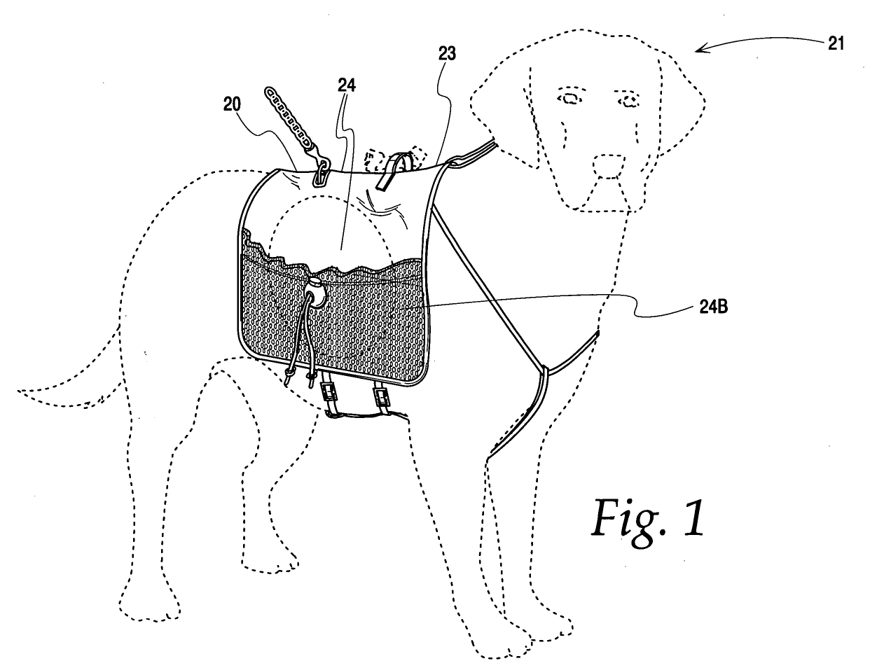

Turning first to FIG. 1, a first exemplary embodiment of the present invention, a pet pack 20, is disclosed. As shown in the figure, the pet pack 20 is worn on the back of a pet 21. This allows the pet to carry several items and belongings including heavy and/or large items. As the pack is supported by the entire body, the pack eliminates or at least substantially reduces aches, pains and neck problems associated with the prior art. Additionally, allowing the pet to carry its own belongings allows the owner to carry his or her own packages thereby encouraging travel, leisure walks and exercise. For example, an owner might walk the dog more frequently if he or she is able to let the dog carry its doggy bag and cleaning items while the owner can carry his or her items.

Although a dog is show in FIG. 1, the pet pack 20 may be built for and used by any other pet such as a cat, a lizard, etc. A person of ordinary skill in the art should appreciate that packs of various sizes and weights might be manufactured and adopted for use by pets of various sizes and shapes. In the preferred embodiment, the pet pack 20 is comprised of any durable material which is flexible. Materials such as cloth, vinyl, leather, plastic and other materials known to those skilled in the art may be utilized.

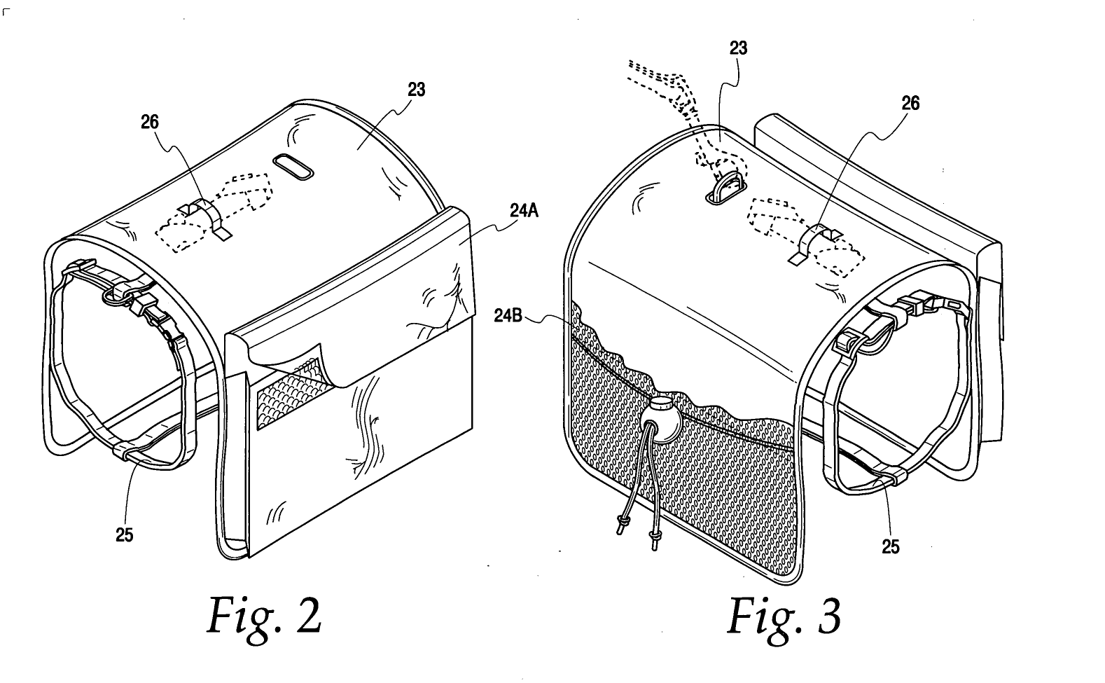

The pet pack 20 generally comprises a top side 23 with a plurality of pockets 24 as shown in FIG. 2. Several types of pockets 24 are present on the pet pack 20. For example, FIG. 2 shows a flap pocket 24a while a drawstring, mesh pocket 24b is disclosed in FIG. 3 on the pet pack. However, it should be appreciated that only one pocket may also be present. A harness 25 is also disclosed and such a harness may be any current harness on the market. In accordance with one aspect of the invention, the accessory pet pack includes a harness attachment on its bottom side. The pet pack 20 is interchangeable with various existing harnesses. As such, a pet can be easily dressed with the pet pack 20 because it can be easily attached to the same harness that a owner might use to put on a leash.

While the pet is wearing a pet pack 20, the owner may attach a leash directly to a leash attachment mechanism such as a loop 26. Other mechanisms which secure a leash to harnesses and pets may also be utilized. In another embodiment, the leash may be attached to the accessory pet pack. Having a leash attached to the pet pack 20 may provide a more comfortable experience for the pet because any pressure on the leash is distributed through the pet pack 20 and the animal's body rather than being concentrated around the animal's neck. Moreover, the leash may be directly attached to the harness 25 itself because part of the harness may still be accessible when combined with the pet pack 20.

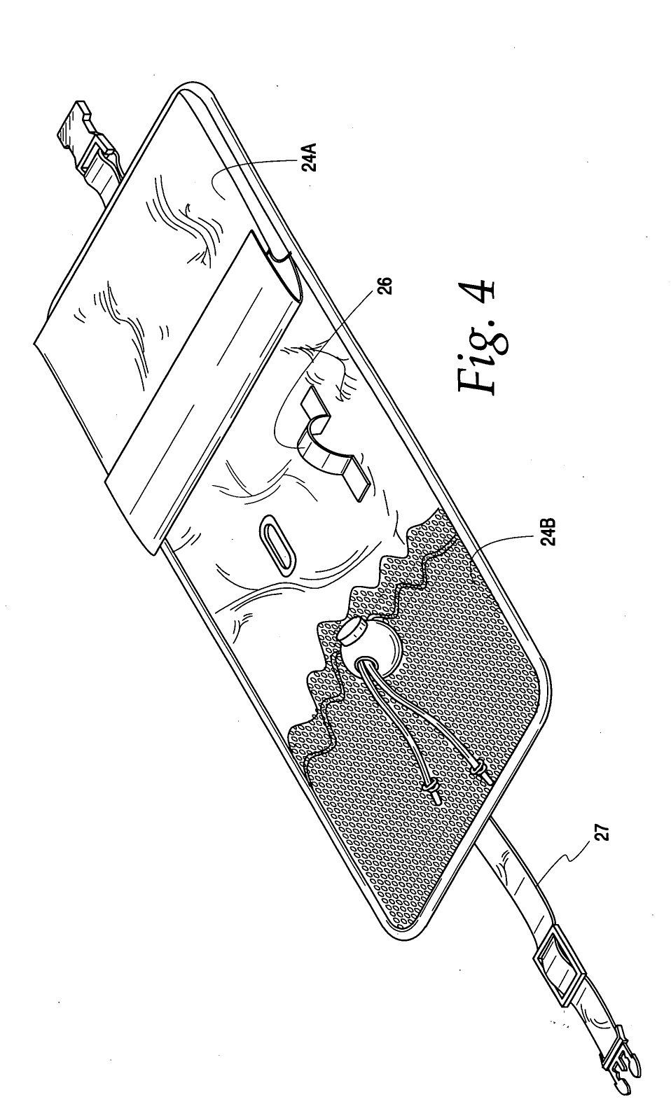

The pet pack further comprises a securing mechanism such as an adjustable strap belt 27 as displayed in FIG. 4. The adjustable strap belt 27 can be adjusted to fit around the pet and snapped in place to secure the pet pack 20. Although a strap belt is used in the preferred embodiment, other types of belts such as buckle, Velcro® or other types may be utilized. Velcro® fasteners may be obtained from Velcro Industries B.V. in Manchester, N.H.

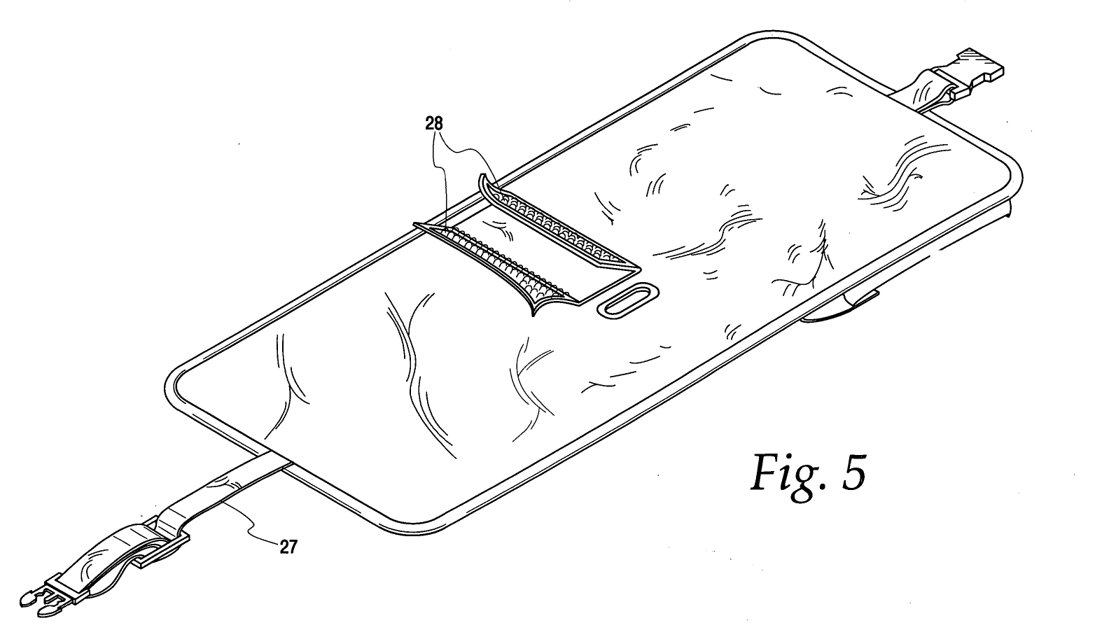

As shown in FIG. 5, the pet pack 20 is attached to a harness by a harness attachment such as a Velcro® hook and eyelet fastener 28. The loop 28 wraps around a portion of the harness. Additionally, the strap 27 is also secured around the pet body. In this manner, the pet pack 20 is secured to the pet.

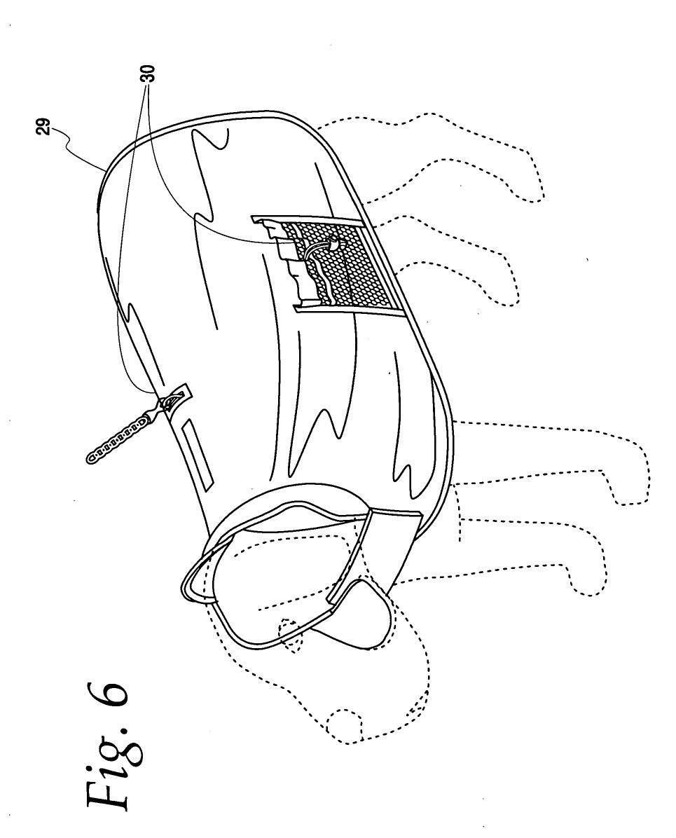

A second exemplary embodiment of the pet accessory of the present invention, a pet coat 29, is provided in FIG. 6. As shown in FIG. 6, the pet coat 29 is worn on the back of a pet. The pet coat 29 entirely or at least substantially covers the pet's 29 body. In another embodiment, the pet coat 29 may further comprise flaps or other extensions which correspond to and at least partially cover a pet's extremities. This protects the pet from weather conditions such as cold or rain. Furthermore, in the preferred embodiment, the pet coat 29 is comprised preferably of a durable, water resistant material. This further protects the pet from water soaking into a sweater which the pet may be wearing. Therefore, the pet coat 29 also protects the health and total well being of a pet. It should be appreciated by those of ordinary skill in the art that other materials may also be utilized.

Although a dog is shown in FIG. 1, the pet coat 29 may be sized and shaped for and used by any other pet such as a cat, a lizard, etc. A person of ordinary skill in the art should appreciate that coats of various sizes and shapes might be manufactured.

The pet coat 29 can also comprise a plurality of pockets 30 on a top side 31. Several types of pockets 30 can be present on the pet coat 29. Although FIG. 7 shows drawstring pockets 30a, the pet coat 29 may comprise open pouches, Velero® closures, button pockets and other types know to those of ordinary skill in the art. However, it should be appreciated that only one pocket may also be present. This allows the pet to carry several items and belongings including heavy and/or large items.

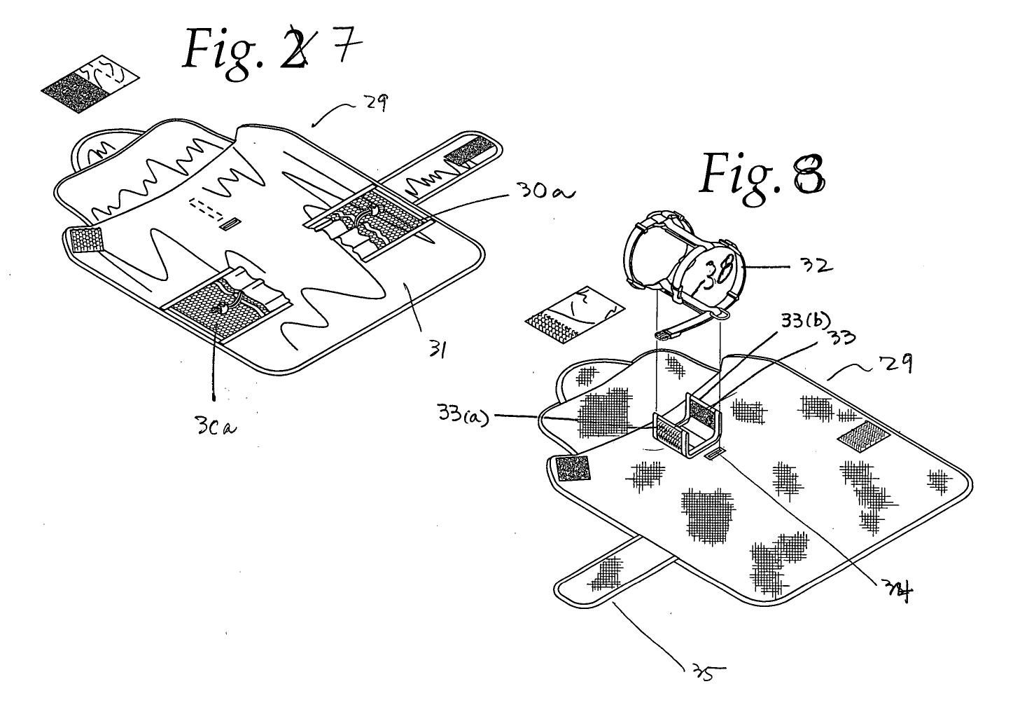

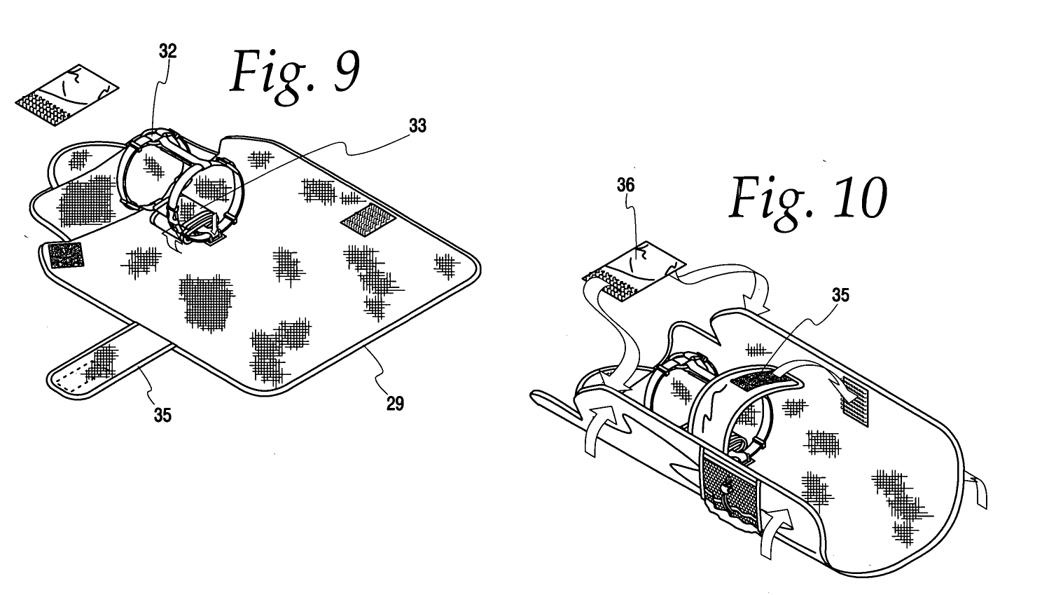

The pet coat 29 is attached to any preexisting harness 32 by a harness attachment such as a Velcro® buckle 33 as shown in FIG. 8. A side of the Velcro® buckle is placed over a strap 38 of the harness 32 and a second side of the Velcro® buckle is attached thereupon. An opening 34 is provided in the pet coat 29 so that a leash attachment portion of the harness 32 may be exposed and used by the owner. As a result the pet coat 29 is secured to the harness 32 as in FIG. 9. The pet coat 29 is interchangeable with various existing harnesses. As such, a pet can be easily dressed with the pet coat 29 because it can be easily attached to the same harness that a owner might use to put on a leash.

In addition, as in FIG. 10, a securing mechanism 35 such as a strap 35 may also be used to secure the pet coat 29 to a pet. In the preferred embodiment, a Velcro® strap is used to wrap the pet coat 29 around the pet's body. However, it should be appreciated that other types of straps such as buckle straps, zipper straps and others may also be used.

Furthermore, a front portion of the pet coat 29 may be wrapped securely around a pet's neck using attachment 36. Hence, the pet coat is secured snugly to the pet.

The specific embodiments discussed in the detailed description are merely illustrative of specific ways to make and use the invention, and do not limit the scope of the invention.

1. A pet accessory comprising, in combination,
a pack comprising substantially durable material;
a harness attachment on a bottom side of said pack wherein said harness attachment is secured to a harness which is independent from said pet accessory; and
a securing mechanism.

2. A pet pack as in claim 20 where said substantially durable material is substantially water resistant.

3. A pet pack as in claim 20 where said substantially durable material is soft on said bottom side.

4. A pet pack as in claim 20 further comprising an opening which allows a portion of the harness to be accessed.

5. A pet accessory comprising, in combination,
a pack comprised of a substantially durable material and including at least one pocket on a top side;
a harness attachment on a bottom side of said pack wherein said harness attachment comprises a first element and a second element to receive a harness strap of an independent, separate pet harness between said first and second elements;
and further wherein said first element of said harness attachment is placed over said harness strap and said second element of said harness attachment is attached to said first element to form a substantially tubular receiver to receive said harness strap and to allow said harness attachment to inhibit substantial lateral movement of said pack across said harness while allowing some movement along a longitudinal length of said harness; and
a securing mechanism attached to said pack.

6. A pet accessory as in claim 5 where said substantially durable material includes a plurality of pockets.

7. A pet accessory as in claim 5 where said substantially durable material is substantially water resistant.

8. A pet accessory as in claim 5 where said substantially durable material is soft on said bottom side.

9. A pet accessory as in claim 5 further comprising a leash attachment mechanism.

10. A pet accessory as in claim 5 further comprising an opening which allows a portion of the harness to be accessed.

11. A pet accessory comprising, in combination,
a coat comprised of a substantially durable material which substantially covers a pet's body;
a harness attachment on a bottom side of said pack wherein said harness attachment comprises a first element and a second element to receive a harness strap of an independent, separate pet harness between said first and second elements;
and further wherein said first element of said harness attachment is placed over said harness strap and said second element of said harness attachment is attached to said first element to form a substantially tubular receiver to receive said harness strap and to allow said harness attachment to inhibit substantial lateral movement of said pack across said harness while allowing some movement along a longitudinal length of said harness; and
a securing mechanism further attached to said pet coat.

12. A pet accessory as in claim 11 where said substantially durable material includes at least one pocket.

13. A pet accessory as in claim 11 where said substantially durable material is substantially water resistant.

14. A pet accessory as in claim 11 where said substantially durable material at least partially covers a pet's head.

15. A pet accessory as in claim 11 further comprising an opening which allows a portion of the harness to be accessed.

16. A pet accessory as in claim 11 further comprising a leash attachment mechanism.

17. A pet accessory as in claim 11 is substantially soft on said bottom side.

18. A pet accessory comprising, in combination,
a pack comprised of a substantially flexible, durable material and having a top side with at least one pocket;
wherein said top side further comprises a leash attachment mechanism;
a harness attachment on a bottom side of said pack wherein said harness attachment comprises a first element and a second element to receive a harness strap of an independent, separate pet harness between said first and second elements;
and further wherein said first element of said harness attachment is placed over said harness strap and said second element of said harness attachment is attached to said first element to form a substantially tubular receiver to receive said harness strap and to allow said harness attachment to inhibit substantial lateral movement of said pack across said harness while allowing some movement along a longitudinal length of said harness; and
a securing mechanism attached to said pack which may be adjusted to fit around the abdomen of a pet.

19. A pet accessory comprising, in combination,
a pack comprised of a substantially flexible, durable material and having a top side with at least one pocket;
wherein said top side further comprises an opening which exposes a leash attachment mechanism of said harness;
a harness attachment on a bottom side of said pack wherein said harness attachment comprises a first element and a second element to receive a harness strap of an independent, separate pet harness between said first and second elements;
and further wherein said first element of said harness attachment is placed over said harness strap and said second element of said harness attachment is attached to said first element to form a substantially tubular receiver to receive said harness strap and to allow said harness attachment to inhibit substantial lateral movement of said pack across said harness while allowing some movement along a longitudinal length of said harness; and
a securing mechanism attached to said pack which may be adjusted to fit around the abdomen of a pet.

20. A pet accessory comprising, in combination,
a pack comprised of a substantially durable material;
a harness attachment on a bottom side of said pack, wherein said harness attachment comprises a first element and a second element to receive a harness strap of an independent, separate pet harness between said first and second elements;
and further wherein said first element of said harness attachment is placed over said harness strap and said second element of said harness attachment is attached to said first element to form a substantially tubular receiver to receive said harness strap and to allow said harness attachment to inhibit substantial lateral movement of said pack across said harness while allowing some movement along a longitudinal length of said harness; and
a securing mechanism further attached to said pack which may be adjusted to fit around the abdomen of a pet.
